(19) United States
(12) Patent Application Publication
(10) Pub. No.: US 2019/0168258 A1
(43) Pub. Date: Jun. 6, 2019

(54) COMPOSITIONS AND METHODS FOR CREATING FUNCTIONALIZED, ROUGHENED SURFACES AND METHODS OF CREATING REPELLANT SURFACES

(71) Applicant: Adaptive Surface Technologies, Inc., Cambridge, MA (US)

(72) Inventors: Philseok KIM, Waltham, MA (US); Gurminder Kaur PAINK, Somerville, MA (US); Jeffrey Elizee D'EON, Cambridge, MA (US); Grant William TREMELLING, Marlborough, MA (US)

(21) Appl. No.: 16/321,018

(22) PCT Filed: Jul. 26, 2017
(86) PCT No.: PCT/US2017/043915

§ 371 Date: Jan. 26, 2019

Related U.S. Application Data
(60) Provisional application No. 62/367,196, filed on Jul. 27, 2016.

(51) Int. Cl. B05D 5/02; B05D 5/08; C09D 127/18; B05D 1/12

(52) U.S. Cl. CPC B05D 5/02; B05D 5/08; C09D 127/18; B82Y 30/00; B05D 2401/10; B05D 2602/00; B05D 1/12

(57) ABSTRACT

The present teachings relate to compositions and methods for creating a functionalized, roughened surface in a single application, which surface can be uniformly-textured and have strong chemical affmity to a selected lubricant. The compositions can include a solvent, nanoparticles having a narrow particle size distribution, a binder, and an additive. The textured surfaces of the present teachings can have an affinity for a lubricating liquid such that a smooth immobilized, stable liquid overlayer of the lubricating liquid can be present in, on, and over the functionalized, roughened surface thereby creating a robust slippery liquid-infused porous surface that is repellant.

### CROSS REFERENCE TO RELATED APPLICATIONS

This application claims priority from U.S. Provisional Application No. 62/367,196, filed Jul. 27, 2016. The entire contents of the provisional application are incorporated herein by reference as though presented at length herein.

### GOVERNMENT INTEREST

There is no U.S. government interest in the present application or the invention claimed therein.

### FIELD

The present teachings relate to compositions and methods for creating a functionalized, roughened surface, which has a non-hierarchical and uniformly textured and roughened surface and an affinity for a lubricating liquid such that an immobilized, stable liquid overlayer of the lubricating liquid can be present on, over and above the functionalized, roughened surface.

### BACKGROUND

In some applications, it is desirable to have a highly repellent surface that is capable of providing anti-fouling characteristics. Currently, one of the leading technologies capable of providing the desired repellency, is known as superhydrophobic surfaces. Inspired by the “lotus effect,” these surfaces provide a certain surface texturing, or porosity, that is capable of trapping small air pockets on the surface when exposed to water. This causes the water to bead into a near-spherical shape, known as the “Cassie-Baxter state,” as shown in FIG. 1a. These droplets can easily roll off such a surface with minimal efforts. Despite the benefits of such surfaces, the majority of them are fragile and are limited in terms of temperature, pressure and the type of liquids which can be repelled. For example, the underlying air pockets can be filled with water or other fluid(s), due to high pressure, extreme temperatures, low surface tension or other harsh and/or adverse conditions. In fact, the wetted textured surface is more adhesive than a flat untextured surface. This phenomenon, when liquid is trapped within the air pockets is known as the “Wenzel state,” as shown in FIG. 1b.

To overcome the drawbacks of superhydrophobic surfaces described above, recent approaches to create robust superhydrophobic surfaces have been focused on creating roughened and highly porous surfaces with re-entrant curvatures to promote effective contact line pinning at the asperities of micro/nanotexture and to prevent transition to the “Wenzel state” when the contact line of the liquid further advances into the pores to fill the pores. Although highly sophisticated silicon micromachining techniques can create ideally designed surfaces with one or more re-entrant curvatures (PNAS 105(47) pp 18200-18205, 2008; Science 346(6213), pp. 1096-1100, 2014), practically useful approaches typically rely on creating hierarchically textured surfaces where there are more than one length scales of roughness, e.g. creating a nanoscale texture on top of a microscale texture, or creating multi-hierarchical textures.

Slippery liquid infused porous surfaces technology is a groundbreaking invention (U.S. Pat. Nos. 9,121,306; 9,121,307; and 9,353,646) to overcome the general drawbacks of superhydrophobic surfaces failing to work due to the transition from the “Cassie-Boxter” state to the “Wenzel state”. By filling the pores with a highly repellant liquid or “lubricant,” the possibility of attaining Wenzel state is eliminated and a slippery surface with non-fouling characteristics is realized especially when such a lubricant liquid forms a smooth and homogeneous interface over the porous solid surface. A key to attaining a robust SLIPS surface is a method to produce an underlying textured surface that is uniformly textured at nanoscale and non-hierarchically porous surface, as described by Kim et al. (Nano Letters 13(4) pp 1793-1799, 2013), provides the capillary forces required to trap and stabilize the repellant liquid overlayer, and perfectly matches the surface chemistry to the liquid lubricant applied.

However, many commercially available superhydrophobic spray products are not ideal for creating ideally smooth SLIPS since they are developed to create more hierarchically porous surfaces to promote the “Cassie-Baxter” state.

Commercially available superhydrophobic spray-on coatings such as Fluorothane™ WX2100 (Cytonix Corporation) and NeverWet® (Ross Technology Corporation) fail to provide the necessary uniform and nanoscale texture or porosity required to trap and stabilize the lubricant, presenting an ultrasmooth interface without hierarchy. Superhydrophobic surfaces are most effective when the surface is composed of re-entrant features, or hierarchically-textured structures with surface features of multiple length scales, making it difficult for liquids to enter the pores and achieve Wenzel state. Consequently, these commercially-available sprays attempt to achieve multi-layer texturing typically of micron-sized features covered in sub-micron (nanoscale) features. Practically, this texturing is achieved by combining two different sized fillers or particles into a base matrix prior to spraying or painting the formulation onto the substrate. See, e.g., FIG. 2.

In the case of Fluorothane™ WX2100, both the micron scale particles and nano scale particles are combined in one solution. When sprayed onto a surface, the micron scale particles create large peaks and valleys that are then conformably covered by the nano scale particles. This one-pot spray formulation cures into a system containing the desired multi-layer hierarchical structure optimized for superhydrophobicity.

NeverWet® brand products use a similar concept but break the formulation into 2 separate parts. First an adhesive base coat containing only micron-sized particles that generate micron-sized roughness is applied. Before the base coat fully sets a second topcoat is applied containing the secondary nano scale particles creating hierarchically textured surface in favor of forming a robust superhydrophobic surface. Fluorothane™ WX2100 and NeverWet® are designed to achieve hierarchically-textured surfaces using slightly different techniques. However, surprisingly these products do not create a surface necessarily optimized for creating a robust slippery surface which can maintain a smooth and stable liquid overlayer.

Thus, there is a need to improve the compositions for a scalable formulation that can be sprayed or painted onto a substrate to provide a functionalized, uniformly roughened surface optimized for creating a slippery liquid-infused porous surface such as those disclosed in U.S. Pat. Nos. 9,121,306; 9,121,307; and 9,353,646.

### SUMMARY

In light of the foregoing, the present teachings provide compositions and methods that can address various deficiencies and/or shortcomings of the state-of-the-art, including those outlined above. For example, the present teachings provide one-pot compositions or formulations that can provide in a single application, a uniformly nanotextured surface which is well-suited for creating a stable slippery liquid surface. The textured surface created by the present teachings can be substantially uniformly-textured or uniformly-textured.

The present teachings extend and improve on the previous slippery liquid-infused porous surface technology by further engineering the base resin or binder (to provide the textured surface) and lubricant of the compositions or system. Previous surface formulations for making a slippery liquid-infused porous surface often failed under specific conditions where certain fouling agents have a high affinity for the base binder and are capable of displacing the lubricant overlayer and/or penetrating through the lubricant layer at defect sites to directly damage the underlying binder layer causing failure. By adjusting the chemistry of the binder, per the present teachings, greater repellency and durability of the coating layer and the liquid can be provided, further optimizing the slippery liquid-infused porous surface system.

The present teachings provide a one-pot composition that can be sprayed to form a film or coating at large scale after drying and/or curing at room temperature in such a way as to provide a uniformly nano-porous surface capable of holding and stabilizing a lubricous liquid within and on top of the porous (textured) surface to form a slippery liquid-infused porous surface. The composition can control the structure of the resultant porous surface as well as the surface chemical properties to allow and enhance one or more of the following desirable and useful properties: 1) minimize pinning points 2) minimize crack formation which favors hierarchical surface texture non-ideal for creating SLIPS, 3) improve cohesive properties of the film (i.e., minimize particles picked up when rubbed), 4) provide increased stability and longevity of the lubricous overlayer, 5) provide stability against more aggressive fouling agents that can displace the lubricant pre-wetted on the textured surface, 6) improve adhesion to substrates, 7) improve mechanical strength of the formed film or coating, 8) improve optical properties, and 9) allow for a method to remove a formed film or coating when needed. Once lubricated, the surface can present a mechanically-robust base coat with a non-stick, lubricous overlayer that can be replenished via re-lubrication, for as long as the base coat remains intact.

More specifically, the present teachings generally provide a composition for creating a functionalized, roughened surface, preferably in a single application. The composition generally includes a solvent, nanoparticles having a narrow particle size distribution, a binder, and an additive. The nanoparticles are dispersed in the solvent; and the binder is soluble in the solvent. The composition can provide a uniformly-textured surface suitable for forming a smooth liquid lubricant overlayer surface when treated with a lubricating liquid. That is, the resulting functionalized roughened surface typically is uniformly-textured, although not necessarily optimized to achieve a robust superhydrophobic surface, and is suitable for forming a slippery liquid-infused porous surface with an appropriate lubricating liquid.

In another aspect, the present teachings provide methods of creating a functionalized, roughened surface, suitable for forming a slippery liquid-infused porous surface with an appropriate lubricating liquid. The method generally includes dispersing nanoparticles having a narrow particle size distribution in a solvent including a binder to form a roughening composition; applying the roughening composition to a surface; and removing the solvent from the roughening composition on the surface and curing the binder, if needed, to form a coating comprising a functionalized, roughened surface.

In yet another aspect, the present teachings provide methods of creating a repellant surface, for example, a slippery liquid-infused porous surface. The methods generally include forming a functionalized, roughened surface according to the present teachings; and applying a lubricating liquid to the functionalized, roughened surface, where the lubricating liquid has a chemical affinity for the functionalized, roughened surface such that, at atmospheric pressure, the lubricating liquid is substantially immobilized in, on and over the functionalized, roughened surface, without dewetting from the substrate, to form a repellant surface.

The foregoing as well as other features and advantages of the present teachings will be more fully understood from the following figures, description, examples, and claims. The contents of all patents, patent applications, and publications/broadcast in any media cited herein are incorporated herein by reference as though fully presented herein.

### DESCRIPTION OF DRAWINGS

It should be understood that the drawings described below are for illustration purposes only. Like numerals in different figures generally refer to like parts. The drawings are not necessarily to scale, with emphasis generally being placed upon illustrating the principles of the present teachings. The drawings are not intended to limit the scope of the present teachings in any way.

FIG. 1 (Prior Art) with parts a and b, referred to herein as FIGS. 1a and 1b, present schematic diagrams of a side cross-sectional view of: (1a) a textured superhydrophobic surface showing Cassie-Baxter state, and (1b) the same textured surface failing under more harsh conditions and irreversibly becoming Wenzel-state.

FIG. 2 is a schematic diagram of a side cross-sectional view of a hierarchical structure obtained by Fluorothane™ WX2100 by using a combination of two particles in the presence of a base binder, and NeverWet® by using the first layer creating a microscale texture and the second layer creating a nanoscale texture atop. These hierarchal structures are optimized for superhydrophobicity but fail to achieve an ideal textured surface for SLIPS.

FIG. 3, with parts a-f, referred to herein as FIGS. 3a-3f, present schematic diagrams of a side cross-sectional view of: (a) a hierarchically textured superhydrophobic surface, (b) a uniformly nano-textured superhydrophobic surface, (c) a hierarchically structured surface when infused with lubricant, (d) a uniformly nano-textured surface when infused with lubricant, (e) the above sample after being exposed to high shear rates/environmental wear, and (f) the above sample after being exposed to high shear rates/environmental wear. The experiment outlines how FIG. 3f is a preferred choice when providing a slippery liquid-infused porous surface. Kim et al., Nano Letters 13:1793-1799 (2013).

FIG. 4, with parts a-c, referred to herein as FIGS. 4a-4c, present schematic diagrams of a side cross-sectional view of: (a) a coating under-loaded with particles such that the majority of the surface is binder, (b) a coating over-loaded with particles such that the particles are simply resting on the surface and can be brushed off easily, and (c) a good balance between the amount of binder and particles such that the particles are exposed at the surface but still remain trapped inside and/or within the matrix.

FIG. 5, with parts a-d, referred to herein as FIGS. 5a-5d, present schematic diagrams of a side cross-sectional view of a lubricated surface where: (a) there are insufficient particles in the formulation to create the surface texturing required to immobilize the lubricant, (b) a slightly increased particle loading where the lubricant is partially immobilized and the fouling agent can slide but over time will displace the lubricant, (c) a particle loading such that a stable lubricant layer is present that can completely repel the fouling agent, and (d) an over-loaded system that presents pinning points where the fouling agent can adhere to the particles extruding out of the lubricant layer. FIG. 5c depicts a slippery liquid-infused porous surface at a thickness such that only lubricating liquid forms the surface above the functionalized, roughened surface (i.e., a smooth liquid interface is presented to the environment).

FIG. 6, with parts a and b, referred to herein as FIGS. 6a-6b, present schematic diagrams of a side cross-sectional view of an embodiment of a functionalized, roughened surface of the present teachings showing that a bulk coating, which contains particles embedded inside the matrix, can present a new surface containing the desired particles and porosity at the surface after exposing the coating to mechanical abrasion.

FIG. 7 is a graph of lubricant retention versus spin speed, where lubricant retention, by mass, was measured for two commercially-available coatings as well as the formulation of Example 2. The lower lubricant retention confirms the smaller pore size required to optimize a slippery liquid-infused porous surface.

FIG. 8 shows the evaluation of film slippery properties via droplet speed on the formulation of Example 2, Fluorothane™ WX2100, and NeverWet®, after the samples were spun at 10,000 rpm to remove excess lubricant. The formulation of Example 2 possessed the fastest shedding speed of the three surfaces.

FIG. 9 is a graph outlining four regions of a lubricated surface where, (a) the surface has insufficient texturing and the droplet pins to the base matrix, (b) where the droplet can slide but eventually wets the base matrix with time, (c) where the droplet slides freely and does not touch the base matrix, and (d) where the loading is so high that the droplet speed is reduced because the droplet pins to extruding particles. See also FIG. 5 and text below related to FIGS. 5 and 9.

FIG. 10 is a scanning electron microscope image of the formulation of Example 1 sprayed on glass prior to lubrication, demonstrating both the porosity as well as the particles (white spots) being exposed at the surface. The surface contains sub-micron sized features that are small enough such that once the surface is infused with lubricant, the features are incapable of protruding out of the liquid overlayer to form point defects.

FIG. 11, with parts a and b, referred to herein as FIGS. 11a-11b, present photographs of: (a) the formulation of Example 1 sprayed on glass containing poly(tetrafluoroethylene-co-hexafluoroproylene) (Viton®, Dupont) as a film forming agent that dried too quickly due to insufficient quantities of Parachlorobenzotrifluoride (Oxsol-100, Rust-Oleum) causing cracking, and (b) the formulation of Example 1 sprayed on glass with no Viton and containing much higher levels of Oxsol-100 to slow the drying process eliminating crack formation.

FIG. 12, with parts a-d, referred to herein as FIGS. 12a-12d, present photographs of: (a) the formulation of Example 1 sprayed on high-density polyethylene (HDPE) and lubricated with Krytox® perfluoropolyether (PFPE) oil GPL 100 (Dupont) with a deposit of masterbatch dark blue and silver dye, (b) the formulation of Example 1 sprayed on HDPE with Krytox® PFPE oil GPL 105 with a deposit of dark blue and silver dye, (c) the samples in FIG. 13a tilted vertically after 24 hours, demonstrating the inability of the low viscosity GPL 100 to repel the high viscosity silver dye; and (d) the samples in FIG. 13b tilted vertically after 24 hours, demonstrating improved performance using GPL 105, a higher viscosity PFPE oil.

FIG. 13, with parts a and b, referred to herein as FIGS. 13a-13b, present photographs of: (a) the formulation of Example 1 sprayed on HDPE and lubricated with GPL 105 (similar to FIG. 12d) but excess lubricant was removed by spin coating (more harsh conditions than FIG. 12d) and the sample was tilted vertically after 24 hours demonstrating failure; and (b) the formulation of Example 2 sprayed on HDPE and lubricated under the same conditions as in FIG. 13a demonstrating that improved performance can be achieved by selecting an appropriate base resin.

FIG. 14, with parts a-c, referred to herein as FIGS. 14a-14c, present photographs of: (a) a typical non-stick perfluoropolyether (Teflon®, Dupont) sample, (b) standard superhydrophobic coating on glass, and (c) the formulation of Example 1 lubricated with GPL 100, where all samples were exposed to blue-dyed water, yellow-dyed silicone oil and red-dyed hexadecane. The samples were tilted at 45° and only (c) was able to repel all three liquids demonstrating the non-stick and omni-phobic characteristics of the coating.

FIG. 15, with parts a-c, referred to herein as FIGS. 17a-15c, present photographs of time lapse images on white HDPE coupons uncoated control (left half of images) and coated with the formulation of Example 1 and lubricated with GPL 100 (right half of images) exposed to commercially available synthetic motor oil and tilted at about 75°, where: (a) depositing material on the surface, t=0 s, (b) additional material added, t=20 s, and (c) the end result demonstrating the ability to completely repel motor oil in less than 2 minutes.

FIG. 16, with parts a and b, referred to herein as FIGS. 16a and 16b, present photographs of time lapse images on grey HDPE coupons uncoated control (left half of images) and coated with the formulation of Example 2 and lubricated with GPL 105 (right half of images) exposed to standard paint colorants (time displayed m:ss) and tilted at 30°, where: (a) top row was exposed to yellow paint colorant, and (b) bottom row was exposed to magenta (red) colorant. The figures demonstrate how a surface made with the formation of Example 2 can be entirely evacuated in 2-3 minutes and remain clean.

FIG. 17, with parts a-c, referred to herein as FIGS. 17a-17c are photographs of time lapse images on flat aluminum coupons uncoated control (left half of images) and coated with the formulation of Example 2 lubricated with GPL 105 (right half of images) exposed to 3 different UV curable resins and tilted at 30°, where: (a) top row was exposed to a clear resin, (b) middle row was exposed to a black resin, and (c) bottom row was exposed to a translucent blue resin. The figures demonstrate complete evacuation of the coated surface after approximately 2 minutes unlike the control surface that remains fouled.

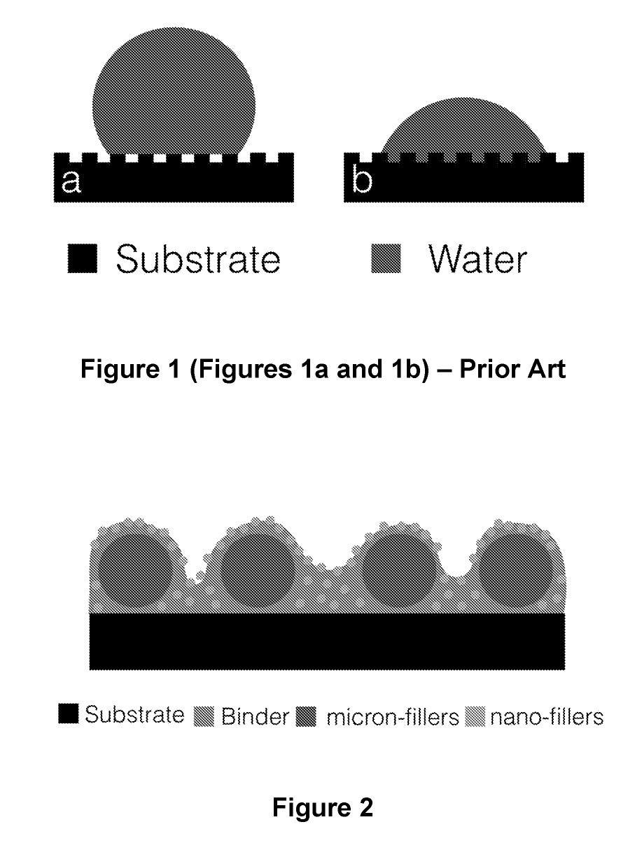

### DETAILED DESCRIPTION

It now has been discovered that a substantially uniformly-textured or a uniformly-textured surface formed from a one-pot spray formulation described in the present application, which can be more advantageous than a hierarchically-textured surface for creating a slippery liquid-infused porous surface, can be created in a single application without additional multi-step treatment (e.g. boiling water treatment and surface functionalization) and with better mechanical properties than previously known. That is, a functionalized, roughened surface can be created that is substantially uniformly-textured such that the surface can immobilize a lubricating liquid (lubricant) to form a layer of liquid over and above the surface thereby presenting a smooth liquid interface with minimal, undesirable pinning points. These pinning points lead to a non-flat liquid interface conforming to the topography created by a larger length scale roughness than the nanoscale (e.g. microscale texture, potential protrusion of larger length scale peaks of underlying solids above the liquid surface, incomplete coverage of the lubricant failing to form liquid overlayer around cracks where underlying solids can be exposed acting as pinning points). Such exposed surfaces can act as a ‘defect point’ where liquid can pin and contribute to increased contact angle hysteresis and as a starting point to dewet the pre-wet lubricant and eventually displace the lubricant. Therefore, it is essential to cover all the solid surfaces with a stable layer of lubricant (i.e. liquid overlayer) and to avoid forming any composite interface where both liquid and solid can present together. Accordingly, the present teachings provide compositions and methods for creating a functionalized, roughened or textured surface that can have feature sizes of a narrow size distribution, which compositions and methods can include a single step application of a composition of the present teachings that can be applied by spraying, dip coating, or any other conventional solvent deposition processes known in the art that are practical for industrial applications.

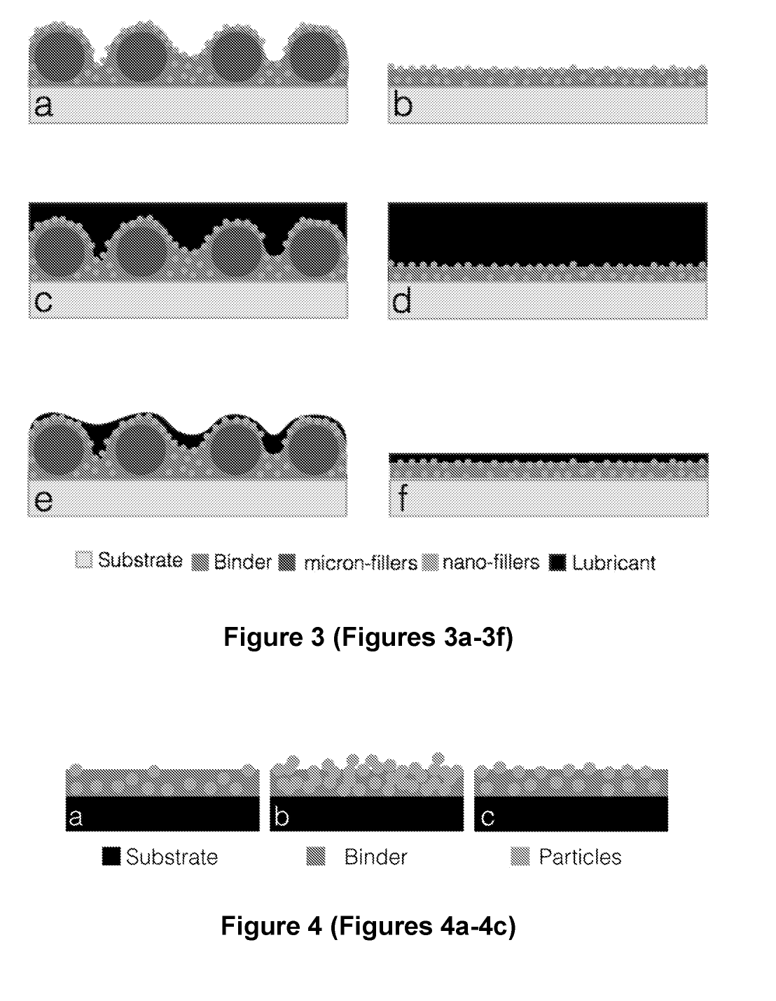

In a paper by Kim et al. (Co-author Kim is one of the co-inventors herein) entitled, “Hierarchical or Not? Effect of the Length Scale and Hierarchy of the Surface Roughness on Omniphobicity of Lubricant-Infused Substrates,” Nano Letters 13:1793-1799 (2013), the performance of slippery liquid-infused coatings were evaluated. In summary, a hierarchically-textured surface when exposed to high shear rates was capable of retaining more lubricant liquid by mass, due to its larger pore size, but the performance of the slippery liquid-infused surface was highly compromised due to large micron-sized features extending out of the lubricant overlayer and the lubricant liquid overlayer being conformal to the microscale texture rather than flat and smooth. On the other hand, a uniformly nano-porous surface per the present teachings exhibited much less lubricant retention by mass, due to its smaller pore size; however, the slippery liquid-infused surface performance was retained because flat and smooth lubricant liquid overlayer was maintained. A pictorial representation of the experiment can be seen in FIGS. 3a-3f, where the more uniformly-textured surface is superior to the hierarchically-textured surface as a support surface for a slippery liquid-infused porous surface.

Accordingly, the functionalized, roughened surface of the present teachings preferably is not a hierarchically-textured surface but rather a substantially uniformly-textured or a uniformly-textured surface. Such a uniformly-textured surface can be created using nanoparticles having a narrow particle size distribution such as a monodisperse population of nanoparticles. That is, a narrow particle size distribution can be described as monodispersed. By using a dispersion of suspended particles having a narrow particle size distribution, a porous or textured coating or film can be realized that has a smaller variation in its surface topography but maintains sufficient porosity to stably immobilize a lubricant within, on and over the porous coating.

In various embodiments, a narrow particle size distribution can have a standard deviation of about 90% from an average (or mean) particle size of the population of nanoparticles. In various embodiments, the narrow particle size distribution can have a standard deviation of about 80% from an average particle size, of about 75% from an average particle size, of about 70% from an average particle size, of about 60% from an average particle size, of about 50% from an average particle size, of about 40% from an average particle size, of about 30% from an average particle size, of about 20% from an average particle size, or less.

With respect to creation of a uniformly-textured surface rather than a hierarchically-textured surface, a hierarchically-textured surface typically refers to two different length scale features that form the porosity of the structure on the surface. The difference between the two different length scales should be at least an order of magnitude, i.e., 10¹ or 10 times, different. Accordingly, with this hypothesis as a guide, to avoid creating a hierarchically-textured surface, the ratio of a primary feature size to a secondary feature size of solids in the composition such as nanoparticles can be less than about 10, less than about 9, less than about 8, less than about 7, less than about 6, less than about 5, less than about 4, less than about 3, or less than about 2. A primary feature size can be a particle size at the upper end of the particle size distribution range and a secondary feature size can be a particle size at the lower end of the particle size distribution.

Although under an order of magnitude difference between a primary feature size and a secondary feature size can provide a textured surface of the present teachings, often hierarchical structure features are discussed in terms of micro- and nano-scaled features, which size difference is three orders of magnitude, i.e., 10³ or 1000 times, different. While such a large size difference in a particle size distribution range can create a hierarchically-textured surface, a grey area exists between this size difference and a one order of magnitude size difference. That is, a defined number as to where the cross-over occurs from one textured surface to the other is dependent on many different factors that influence the formation of the textured coating such as the composition of the nanoparticles and the binder, their compatibility with the solvent, the dispersion of the nanoparticles in the composition, the setting and/or curing time from application of the composition to its formation, and so on. Thus, a ratio of a primary size feature to a secondary size feature can be greater than 10 and provide a non-hierarchically-textured coating or surface, i.e., a substantially uniformly-textured coating, film or surface, using compositions and methods of the present teachings.

For example, in certain embodiments, the nanoparticles can form agglomerates when applied to a substrate or surface. Agglomerates of nanoparticles can be present in the compositions if the nanoparticles are not dispersed sufficiently or appropriately, or for other reasons such as the compatibility of the nanoparticles with the binder and/or the solvent. In such cases where agglomerates of nanoparticles are present on the surface, a primary feature size can be the size of the agglomerates (e.g., an average size or a size at the upper end of the agglomerate size distribution range) and a secondary feature size can be the size of the nanoparticles (e.g., an average size or a size at the lower end of the particle size distribution). In such cases, the ratio of a primary feature size to a secondary feature size can be greater than about 10, for example, greater than about 15, or greater than about 20 or greater than about 25, and provide a non-hierarchically-textured coating or surface, i.e., a substantially uniformly-textured coating or surface, using compositions and methods of the present teachings.

In these cases, without wishing to be bound to any particular theory, it is believed that because an agglomerate is composed of the nanoparticles in the composition, the surface topography of the agglomerate would be similar to the surface topography created by completely dispersed nanoparticles applied to a surface, although having the curvature of the agglomerate rather than conforming to the topography of the surface. Thus, while the largest size feature (e.g., the diameter of the agglomerate) would be larger than the largest nanoparticle size feature and could extend a greater distance from the underlying substrate or surface, a textured coating or film of the present teachings typically is not a mono-layer of nanoparticles but can contain many “layers” of nanoparticles from the surface of the substrate to the exposed surface of the coating. Consequently, a mixture of nanoparticles and agglomerates within the coating or film can present a substantially uniformly-textured surface similar to a textured surface created without any agglomerates present. Accordingly, the ratio of a primary feature size to a secondary feature size can be greater than about 10 and still provide a non-hierarchically-textured surface.

With respect to the stability of the lubricant overlayer, without wishing to be bound to any particular theory, while it is believed that the lubricant overlayer can be stabilized by the chemical affinity between it and the binder, an equal or greater amount of stability can be provided by the textured surface itself. That is, a driving factor stabilizing the lubricant overlayer can be the capillary force created by the functionalized, roughened surface texture, i.e., porosity, of the present teachings.

Another factor in the preparation of the compositions of the present teachings is the particle loading or amount of nanoparticles in the composition. In some embodiments, a strong affinity between the nanoparticles and the binder is desired. In certain embodiments, the affinity between the nanoparticles and the binder is not strong, for example, where the nanoparticles have incompatibility with the binder. Without wishing to be bound to any particular theory, it is believed that where an affinity exists between the nanoparticles and the binder, i.e., they are more compatible, the particle loading can be less or reduced compared to where an incompatibility exists because in the former case, the particles can be dispersed well in the composition while in the latter case, the incompatibility promotes aggregation of the nanoparticles thereby requiring a higher loading of nanoparticles to achieve the textured surfaces of the present teachings.

In practice, a higher loading of particles in a composition including a binder that has incompatibility with the nanoparticles can be useful where mechanical stability of the surface is of lesser importance. In these cases, the resulting coating can be a thicker coating of particles and binder, which coating can provide a desirable surface of the present teachings. Another consideration with respect to compositions having a high particle loading is that less binder will be present in these compositions and consequently, in the resulting surface coating or film. With less binder present, the coating may not be strongly bound to the surface of the substrate and/or can be too porous to provide desired mechanical durability.

In addition, a higher viscosity lubricant can assist in creating a more uniform and/or stable lubricant overlayer. Furthermore, matching the viscosity of the lubricant being used to that of the fouling agent or liquid-to-be-repelled can improve the performance of the slippery liquid-infused porous surface's anti-fouling characteristics. Finally, the formulation can be made such that the solution is low VOC or zero VOC as well as crack-free, for example, by tuning the solvent system of the composition.

Throughout the application, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition, an apparatus, or a method described herein can be combined in a variety of ways without departing from the spirit and scope of the present teachings, whether explicit or implicit herein. For example, where reference is made to a particular structure, that structure can be used in various embodiments of apparatus of the present teachings and/or in methods of the present teachings, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

Where the use of the term “about” is before a quantitative value, the present teachings also include the specific quantitative value itself, unless specifically stated otherwise. As used herein, the term “about” refers to a ±10% variation from the nominal value unless otherwise indicated or inferred.

Where a percentage is provided with respect to an amount of a component or material in a structure or a composition, the percentage should be understood to be a percentage based on weight, unless otherwise stated or understood from the context.

Where a molecular weight is provided and not an absolute value, for example, of a polymer, then the molecular weight should be understood to be an average molecule weight, unless otherwise stated or understood from the context.

It should be understood that the order of steps or order for performing certain actions is immaterial so long as the present teachings remain operable. Moreover, two or more steps or actions may be conducted simultaneously.

At various places in the present specification, numerical values are disclosed in groups or in ranges. It is specifically intended that the description include each and every individual subcombination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

At various places in the present specification, substituents are disclosed in groups or in ranges. It is specifically intended that the description include each and every individual subcombination of the members of such groups and ranges. For example, the term “C₁₋₆ alkyl” is specifically intended to individually disclose C₁, C₂, C₃, C₄, C₅, C₆, C₁-C₆, C₁-C₅, C₁-C₄, C₁-C₃, C₁-C₂, C₂-C₆, C₂-C₅, C₂-C₄, C₂-C₃, C₃-C₆, C₃-C₅, C₃-C₄, C₄-C₆, C₄-C₅, and C₅-C₆ alkyl. By way of other examples, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20. Additional examples include that the phrase “optionally substituted with 1-5 substituents” is specifically intended to individually disclose a chemical group that can include 0, 1, 2, 3, 4, 5, 0-5, 0-4, 0-3, 0-2, 0-1, 1-5, 1-4, 1-3, 1-2, 2-5, 2-4, 2-3, 3-5, 3-4, and 4-5 substituents.

The use of any and all examples, or exemplary language herein, for example, “such as” or “including,” is intended merely to illustrate better the present teachings and does not pose a limitation on the scope of the invention unless claimed. No language in the specification should be construed as indicating any non-claimed element as essential to the practice of the present teachings.

A one-pot sprayable composition of the present teachings can include a suspension in which disaggregated nanoparticles (e.g., average particle size of about 100 nm-120 nm in diameter) are dispersed in a carrier solvent, a base matrix resin (also referred to as a “binder”) dissolved in or emulsified within the solvent, where catalysts, additives, and additional carrier solvents can be present. A goal is to create a primarily nano-porous surface containing either a uniformly nano-textured surface, which can include a hierarchically-textured surface having features much less pronounced than standard superhydrophobic coatings such that no pinning points are capable of protruding out of the lubricant-infused overlayer.

Examples of nanoparticles that can be useful in the present teachings include Zonyl™ MP1000 PTFE particles (Dupont), Zonyl™ MP1100, MP1200, MP1300, MP1400, MP1400F, MP1600 PTFE particles (Dupont), Ultraflon™ MP-55 PTFE particles (Laurel Products), Polyflon™ F-series PTFE particles (Daikin), Algoflon® L100 PTFE particles (Solvay), Aerosil® R200, R202, R812, R812S, or R8200, R9200 (Evonik Industries), Enova® IC3100, Lumira® LA100 (Cabot Corporation), amorphous silicon dioxide hexamethyldisilazane treated (Gelest Inc.), aerogel fine particles (Dow Corning Corporation), fumed silica (Sigma Aldrich Co. LLC), HDS2, HDS3, S125M, S20M (Nyacol Nano Technologies, Inc.), HDK H15 and HDK H20 (Wacker Chemie AG).

Examples of base matrix resins, or base resins, or binders that can be useful in the present teachings include an alkyd binder such as 200-60V (Deltech Corporation), a polyurethane binder, for example, a thermoplastic polyurethane such as Versamid® Pur 1010 (BASF), UR-CRYL© AN-110VM-MD (Deltech Resins), a hydrogenated binder such as Krasol™ HLBH-P 2000, HLBH-P 3000 (Cray Valley), a fluorinated binder, for example, a fluorinated polyurethane such as Lumiflon LF200F and/or Lumiflon LF916F (AGC Chemicals), Capstone® ST-110 (Dupont), Fluonate K-702, K-704 (DIC Corporation), an epoxy binder such as Resydrol® AX 906 (Allnex), and a silicone-alkyd binder such as WorleeKyd BS830 (Worlee).

Examples of solvents that can be useful in the present teachings include water, ethyl acetate, methyl ethyl ketone, methyl isobutyl ketone, acetone, parachlorobenzotrifluoride (e.g, Oxsol-100, Rust-Oleum), decafluoropentane (eg. Vertrel® XF), methoxy-nonafluorobutane (eg. 3M™ Novec™ 7100 Engineering Fluid), mineral spirits, alcohols, glycol ethers, petroleum distillates, n-tert butyl acetate, and mixtures thereof.

To ensure the coatings present the proper porosity optimized for stabilizing the lubricious overlayer, the composition or formulation should contain only one size of nanoparticles, for example, a monodisperse population of nanoparticles, where the nanoparticles are disaggregated prior to being introduced into the base matrix. The processing methods include traditional mixing and homogenization processing methods and tools such as horn or probe sonication, standard ultrasonic bath treatment, ball milling, jar milling, sand milling, rotor-stator, cavitation mixer, blender, overhead mixer, and/or jet milling. In the event that the nanoparticles are not properly disaggregated, the nanoparticles can remain clumped together, causing the resulting coating to be hierarchically-textured with excessively large features, which surface can be desirable for superhydrophobic surfaces but not for pinning point-free slippery liquid-infused porous surfaces.

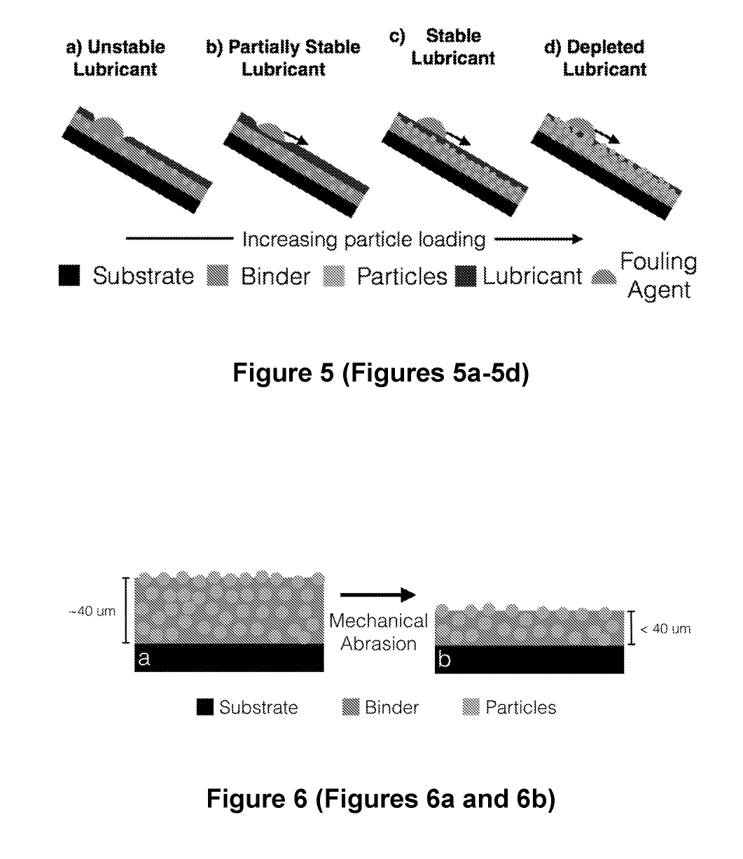

Determining the proper ratio of the nanoparticles and the binder can also play an important role in providing the porosity and the chemical affinity for stabilizing a lubricant overlayer. A goal is to spray a one-pot formulation that cures or sets in such a way as to allow the particles to be exposed at the surface but not so much so that the binder is incapable of holding them in place (see FIG. 4 comparing sub-FIG. 4a, 4b, 4c). This is important for creating a system that is both mechanically robust while still presenting the proper texturing required for stabilizing a uniform lubricant overlayer (see FIG. 5 with optimum at sub-FIG. 3c). The exact particle loading is dependent on the compatibility between the binder and the particles being used and can vary for any given system. Additionally, since the particles are exposed at the surface it is possible to tune the chemistry of the particles such that a greater affinity between the surface and the lubricant exists, helping further stabilize the lubricant overlayer. For example, if the lubricant is fluorinated, using a fluorinated particle can increase the lubricant stability compared to use of a non-fluorinated particle.

Another ingredient or component of the (spray-on) formulation is the solvent or solvent system. A primary consideration when selecting a solvent (system) is compatibility. The solvent (system) must be compatible with the binder while also providing stability for the particle dispersion. Should the solvent (system) be incompatible with the particles or the binder then this leaves the possibility for the particles to re-aggregate or the binder to phase separate out of solution, resulting in an inhomogeneous mixture incapable of producing the proper texturing. A secondary consideration when selecting a solvent (system) is evaporation rate. By tuning the drying profile, the coating or film can set properly, not only exposing the nanoparticles but also improving the mechanical durability of the coating. An uncontrolled drying process can lead to the formation of cracks, simultaneously decreasing the mechanical durability of the film and compromising the uniform texturing required to maintain a stable lubricant overlayer. Accordingly, overall coating quality and functionality can rely on a properly tuned solvent system.

Because an end goal of the present teachings can be a non-stick, repellant, or slippery surface, it is important to consider the material being repelled when selecting a binder or surface modifier. For example, if the coating is composed of an alkyd binder and the material to be repelled has an affinity for alkyd, then under the right conditions the fouling agent can displace the lubricant and directly contact the surface resulting in permanent adhesion. Depending on the material being repelled, the binder should be selected to minimize affinities between itself and the fouling agent, promoting a continuous lubricant interface that can prevent permanent adhesion. Alternatively, the surface chemistry of the binder can be adjusted by means of a surface modifier. Returning to the previous example, instead of replacing the alkyd binder entirely, an additive can be included in small amounts such that the additive can self-stratify to the surface, cross link into the binder network and present a new interface with reduced chemical affinity between the binder and fouling agent. This allows the possibility to tune the chemical affinities between the binder and the fouling agent without needing to change the bulk binder. Adjusting the chemical affinities in the system is important to prevent the permanent adhesion of the fouling agent onto the coating.

Examples of lubricating liquids or lubricants that can be useful in the present teachings include trifluoromethyl C₁₋₄ alkyl dimethicone; polydimethylsiloxanes, trimethylsiloxy terminated; silanols such as silanol terminated polydimethylsiloxanes; silanol terminated diphenylsiloxane-dimethylsiloxane copolymers; silanol terminated, polydiphenylsiloxane; silanol terminated polytrifluoropropylmethylsiloxane; carbinol (hydroxyl) terminated polydimethylsiloxanes containing hydroxypropyleneoxypropyl or hydroxyethyleneoxypropyl segments; (carbinol functional)methylsiloxane-dimethylsiloxane copolymers containing hydroxypropyleneoxypropyl or hydroxyethyleneoxypropyl segments; and monocarbinol terminated polydimethylsiloxanes; aromatic silicones such as diphenylsiloxane-dimethylsiloxane copolymers, phenylmethylsiloxane-dimethylsiloxane copolymers, and phenylmethylsiloxane homopolymers; organic silicones such as alkylmethylsiloxane homopolymer; alkylmethylsiloxane-arylalkylmethylsiloxane copolymer; alkylmethylsiloxane dimethylsiloxane copolymer; polydiethylsiloxanes, triethylsiloxy terminated; phenyl trimethicone; caprylyl methicone; and dodecylmethylsiloxane-2-phenylpropylmethylsiloxane copolymer; fluoro-silicones such as poly trifluoropropylmethylsiloxane and fluoropropylmethylsiloxane dimethylsiloxane copolymer; hydrophilic silicones such as (hydroxyalkyl functional) methylsiloxane-dimethylsiloxane copolymers and dodecylmethylsiloxane-hydroxypolyalkyleneoxypropylmethylsiloxane, copolymer; and hydrocarbon-based oils or hydrocarbon oils such as saturated hydrocarbon oils, cycloalkanes, unsaturated hydrocarbon oils, branched hydrocarbon oils, aromatic hydrocarbon oils such as naphthalene oil, poly(alphalefins), paraffin oil, petroleum or mineral oil, white mineral oil, isoparaffins (Isopar™), and natural or modified biohydrocarbon oils such as vegetable oil, tocopherol, lanolin, and pyrolysis oil.

While the present invention enhances operational service life of an article with a lubricious liquid surface with an overlayer, such overlayer may not be necessarily permanent. If and when the lubricious liquid is depleted, the liquid can be restored from an external source applied directly on the textured surface. In another embodiment, the depleted liquid can be restored from a reservoir via external conduits or conduits within the article connecting to the reservoir of liquid.

By considering and combining the above-described features, a one-pot composition or formulation can be prepared that can provide a porous textured coating, which can stabilize a lubricating liquid overlayer. By tuning the base resin (binder), the nanoparticles and the lubricant, it can be possible to repel virtually any fluid based on any specific application.

Accordingly, the present teachings provide a composition for creating a functionalized, roughened surface in a single application. The composition includes a solvent; nanoparticles having a narrow particle size distribution range, where the nanoparticles are dispersed in the solvent; a binder (base resin), where the binder is soluble in the solvent; and an additive with less than 5 wt. % of the total solids in the composition, where the additive can improve the processing of the composition and/or impart additional functions such as leveling, anti-sagging, defoaming, enhanced matching of surface chemistry to the lubricant, fluorescence, and fragrance. The composition can provide a uniformly-textured surface suitable for forming a smooth liquid lubricant overlayer surface or slippery liquid-infused porous surface.

In various embodiments, the nanoparticles include a polymer, for example, a fluoropolymer; an inorganic material, for example, silica, alumina, titania, or iron oxide nanoparticle. In some embodiments, the nanoparticles include surface modified nanoparticles to present desired surface chemistry. In some embodiments, the nanoparticles may not be in a spherical shape but can be a non-spherical shape such as oval, rice-like, fiber-like, plate-like, or other two dimensional or three dimensional shapes. In such cases, the particle size dimensions, for example, for determining an average particle size, can be measured and be considered to be along the longest dimension of a particle. In some embodiments, the nanoparticles can be described as monodisperse, for example, having a narrow particle size distribution range.

An average particle size of the nanoparticles can be between about 20 nm to about 1000 nm. For example, the average particle size of the nanoparticles can be about 20 nm, 50 nm, about 75 nm, about 100 nm, about 120 nm, about 150 nm, about 175 nm, about 200 nm, about 250 nm, about 300 nm, about 350 nm, about 400 nm, about 450 nm, about 500 nm, about 600 nm, about 700 nm, about 800 nm, about 900 nm, or about 1000 nm. In certain embodiments, the nanoparticles can have a size feature such as a diameter between about 50 nm to about 120 nm, for about 120 nm to about 500 nm, or from about 500 nm to about 1000 nm.

In particular embodiments, the binder includes a fluorinated compound. For example, the binder can include a fluorinated compound where the nanoparticles include a fluorinated compound such as a fluoropolymer. In some embodiments, where the binder and the nanoparticles include a fluorinated compound, the lubricant advantageously can include a fluorinated compound too. In some embodiments, the binder or one of the components of the binder system can be pre-treated to have increased fluorinated character.

In various embodiments, the solids of the composition include between about 10 volume % to about 75 volume % nanoparticles. The solids of the composition can include between about 10 volume % to about 65 volume % nanoparticles, between about 10 volume % to about 55 volume % nanoparticles, between about 10 volume % to about 45 volume % nanoparticles, between about 10 volume % to about 35 volume % nanoparticles, between about 10 volume % to about 20 volume % nanoparticles, between about 20 volume % to about 75 volume % nanoparticles, between about 20 volume % to about 65 volume % nanoparticles, between about 20 volume % to about 55 volume % nanoparticles, between about 20 volume % to about 35 volume % nanoparticles, between about 20 volume % to about 30 volume % nanoparticles, between about 30 volume % to about 75 volume % nanoparticles, between about 30 volume % to about 65 volume % nanoparticles, between about 30 volume % to about 55 volume % nanoparticles, between about 30 volume % to about 50 volume % nanoparticles, between about 50 volume % to about 75 volume % nanoparticles, between about 50 volume % to about 65 volume % nanoparticles, between about 50 volume % to about 60 volume % nanoparticles, between about 60 volume % to about 75 volume % nanoparticles, between about 60 volume % to about 70 volume % nanoparticles, or between about 65 volume % to about 75 volume % nanoparticles.

The composition can further include one or more additives such as a surfactant, a film-forming agent, a pH adjustor, a colorant, a pigment, a suspending agent, a dispersant, a wetting agent, a defoaming agent, an anti-oxidant, a UV-absorber or UV-stabilizer, a leveling agent, a stabilizing agent, a chemical modifier, and a catalyst. In some embodiments, an additive can be used to further increase desired surface character (e.g. fluorinated character).

The composition can use no volatile organic compound (VOC), or can be a low or ultra-low VOC composition.

In another aspect, methods of creating a functionalized, roughened surface can generally include dispersing nanoparticles having a narrow particle size distribution in a solvent including a binder to form a roughening composition; applying the roughening composition to a surface; and removing the solvent from the roughening composition on the surface to form a coating including a functionalized, roughened surface.

In the methods of the present teachings, dispersing nanoparticles can include sonicating nanoparticles in the solvent. The methods can include applying the roughening composition by one or more of spraying, brush painting, roller painting, dip coating, and spin coating the roughening composition. The methods can include removing the solvent from the roughening composition on the surface, for example, by evaporating the solvent. Removing the solvent from the roughening composition on the surface can include controlling the rate of removal of the solvent to provide a crack-free functionalized, roughened surface. Controlling the rate of removal of the solvent can include at least one of altering the solvent blend, altering the evaporation temperature, and altering the evaporation humidity.

The present teachings also provide methods of creating a repellant surface. The methods can include forming a functionalized, roughened surface according to the present teachings; and applying a lubricating liquid to the functionalized, roughened surface. The lubricating liquid can have a chemical affinity for the functionalized, roughened surface such that, at atmospheric pressure, the lubricating liquid is substantially immobilized in, on and over the functionalized, roughened surface, without dewetting from the substrate, to form a repellant surface.

The methods can include applying a lubricating liquid by applying the lubricating liquid in a solvent. The repellant surface can be a smooth liquid surface of the lubricating liquid over and above the functionalized, roughened surface. In particular methods, the lubricating liquid can have a chemical affinity for the nanoparticles and/or the binder. In certain methods, the chemical affinity of the functionalized, roughened surface for the lubricating liquid can be greater than the chemical affinity of the functionalized, roughened surface for a foreign material to be repelled by the repellant surface. In some embodiments, the viscosity ratio of the lubricating liquid to that of a foreign material to be repelled by the repellant surface is close to 1, 1+/−0.25, or 1+/−0.5. In various methods, the lubricating liquid is immiscible with a foreign material to be repelled by the repellant surface. The methods of the present teachings can further include delivering additional lubricating liquid to the repellant surface.

The following examples are provided to illustrate further and to facilitate the understanding of the present teachings and are not in any way intended to limit the invention.

### EXAMPLE 1

A formulation utilizing an alkyd binder as the base matrix (binder) was combined with polytetrafluoroethylene (PTFE) particles. Specifically, Algoflon® L100 PTFE (Solvay) particles with diameter of 100 nm-120 nm were disaggregated in acetone at 20 wt. %. An additive, Viton™ was added at 1 wt. % to the suspension to further impart fluorinated surface chemistry. Disaggregation was achieved by processing the solution with a horn sonicator, Q700 (Qsonica, LLC.) with a probe diameter as recommended by the manufacturer for the given solution volume. The volume varied from 10 mL to 1.5 L depending on the batch size and probe diameter. The solution was sonicated with 5 seconds bursts at 100% amplitude for a total processing time of 40 seconds, or until the nanoparticles were fully suspended (confirmed via solution viscosity). Separately, alkyd binder 200-60V (Deltech Corporation) was diluted using parachlorobenzotrifluoride (Oxsol-100, Rust-Oleum) to a solid content of 20 wt. %. Both parts were combined at 4 parts particle suspension to 3 parts alkyd solution. Once combined, the solution was further sonicated with the previously described settings for an additional 30 seconds to mix both components. The final step consisted of further diluting the solution with both acetone and Oxsol-100 to thin the solution for spraying. The total drying time was controlled based on the quantity of Oxsol-100 added at the end. The solution was then sprayed onto a substrate and allowed a sufficient amount of time to dry.

### EXAMPLE 2

Following the same protocol as in Example 1, the formulation of this example used a fluorinated binder. By replacing the alkyd binder 200-60V with Lumiflon LF200F or Lumiflon LF916F fluorinated binders (AGC Chemicals), a similarly textured surface was produced using Algoflon L100 PTFE particles but at a mixing ratio of 2:1.

### EXAMPLE 3

Following the same protocol as in Example 1, the formulation of this example used an alkyd binder with hydrophobic silica particles. The nanoparticle suspension was achieved using the same processing method but with a silica particle loading of 4 wt. % instead of 20 wt. %. The silica particles were Aerosil® R8200 (Evonik Industries). Otherwise the formulation remained unchanged.

### EXAMPLE 4

Algoflon® L100 PTFE particles were combined with Versamid® Pur 1010 (BASF) as a binder. The formulation contained 3 parts Versamid® Pur 1010 to 7 parts Algoflon® L100 dispersed in ethyl acetate and Oxsol® 100 to improve processing time and dilute the system for spraying. All components were processed together using a method similar to that of Example 1. Once sprayed, the formulation provided a similar texture as with the formulations of Examples 1-3 but by changing the binder to Versamid® Pur 1010, which is a thermoplastic polyurethane, the formulation no longer required curing and sets nearly instantly.

To demonstrate the surfaces of the present teachings as prepared in the examples, pictures are provided. To properly demonstrate that the surface is advantageous for creating a slippery liquid-infused porous surface, some of the experiments conducted by Kim et al. in the Nano Letters paper were recreated using formulations of the present teachings.

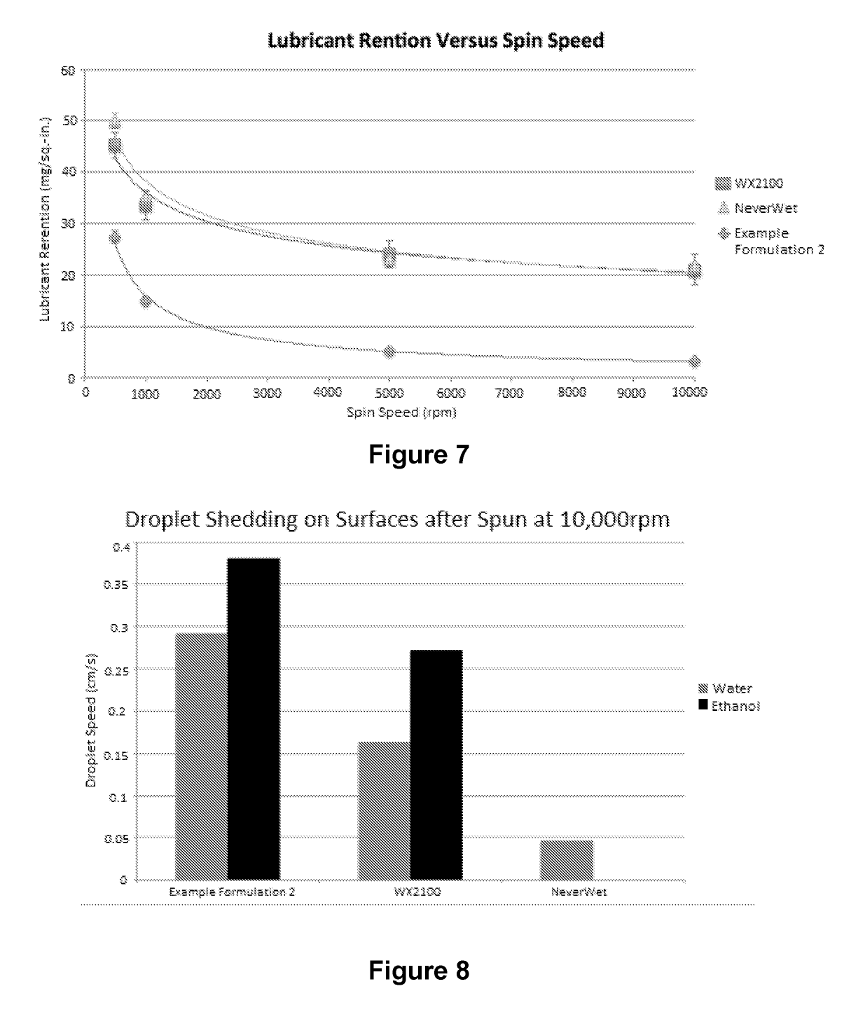

Glass slides were sprayed with the formulation of Example 2, Fluorothane™ WX2100 (Cytonix Corporation) and NeverWet® (Ross Technology Corporation) and then lubricated with Krytox® perfluoropolyether (PFPE) oil GPL 105 (Dupont). The samples were then subjected to increasing shear rates on a spin coater, where at each iteration, the mass loss of lubricant was recorded. FIG. 7 demonstrates how the overall mass of GPL 105 remaining on the surface is much less for the formulation of Example 2. This result is an indication that the formulation of Example 2 has a lower average pore size than both commercially available sprays.

After spinning the samples at 10,000 rpm, the performance of the slippery liquid-infused porous surfaces was evaluated to confirm the presence of a lubricious overlayer. Accordingly, the slides were tilted at an angle of 60°, where the shedding speed of 10 μL droplets of water (surface tension=71.97 mN/m) and of ethanol (surface tension=22.27 mN/m) was measured to evaluate the slippery properties of both high and low surface tension liquids. FIG. 8 demonstrates that after spinning at 10,000 rpm, the formulation of Example 2 still possessed a greater degree of slippery properties than both Fluorothane™ WX2100 and NeverWet® even with 1/7^{th} of the lubricant mass. Thus, the surface was both nano-porous and capable of stabilizing a lubricious overlayer as desired.

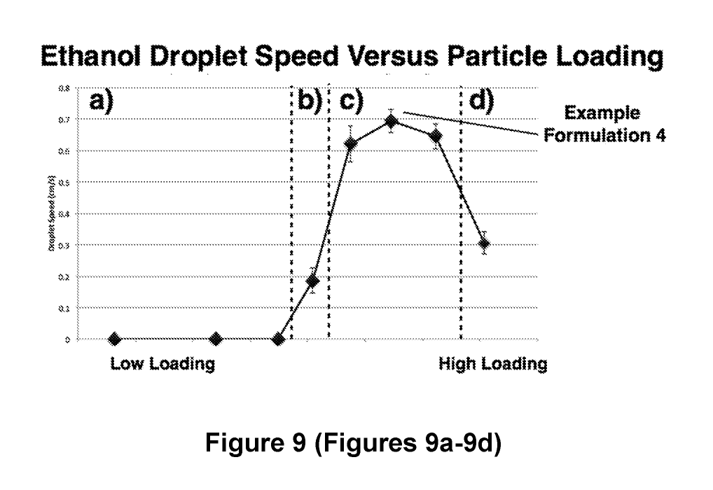

In addition to benchmarking the surfaces of the present teachings versus commercially available products that produce roughened surfaces, a similar approach was used to characterize the surface and adjust the particle loading so as to enhance slippery liquid-infused porous surface performance. With reference to FIG. 5, including sub-FIGS. 5a-5d, the formulation of Example 4 was altered such that there existed over-loaded and under-loaded coatings to demonstrate the effects of particle loading on slippery liquid-infused porous surface performance. The samples were lubricated with Krytox GLP 105 (Dupont) and sheared at 10,000 rpm to deplete the surface. Once depleted, the surfaces were characterized by measuring the speed of a 10 μL ethanol droplet sliding along the surface (see FIG. 9). Sub-FIGS. 5a and 5b show under loading 5c illustrates optimum and 5d shows over loading with FIG. 9 showing ethanol droplet speed vs. particle loading. See the initial descriptions of FIG. 5 and FIG. 9 in the above description of the Drawings section.

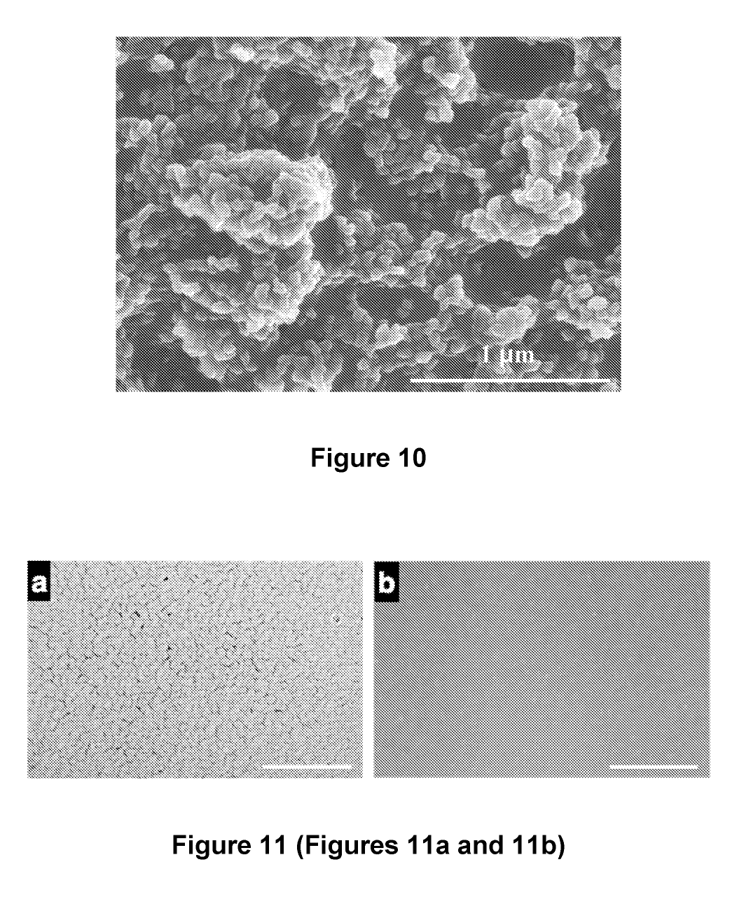

Further confirmation of the surface's structure was made by measuring the contact angle of water on the surface and by directly imaging the surface using a scanning electron microscope (FIG. 10).

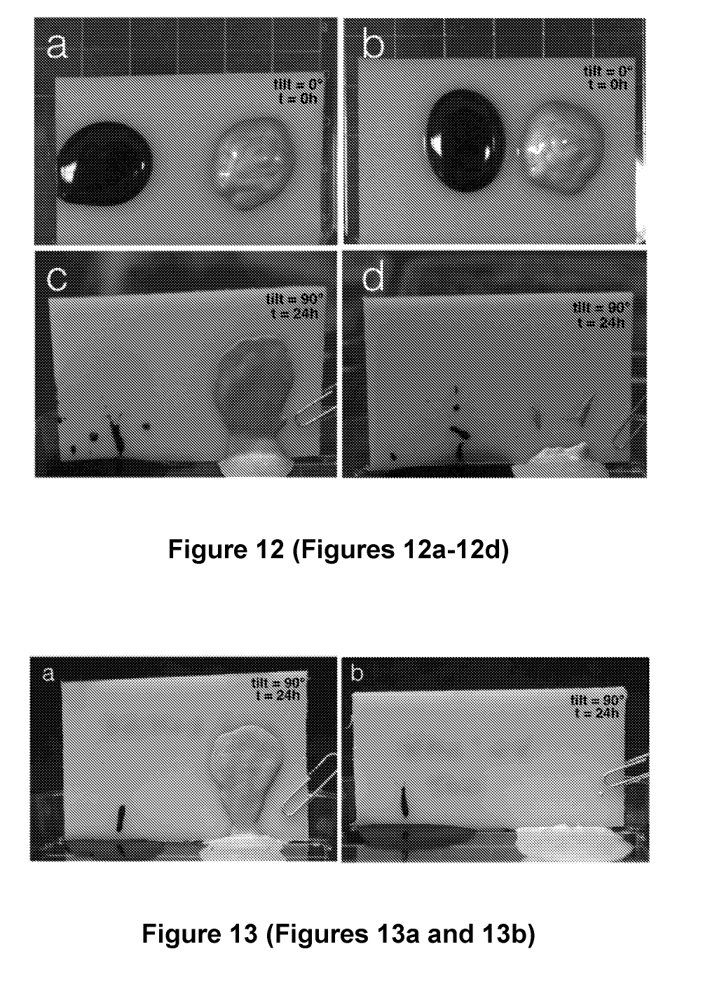

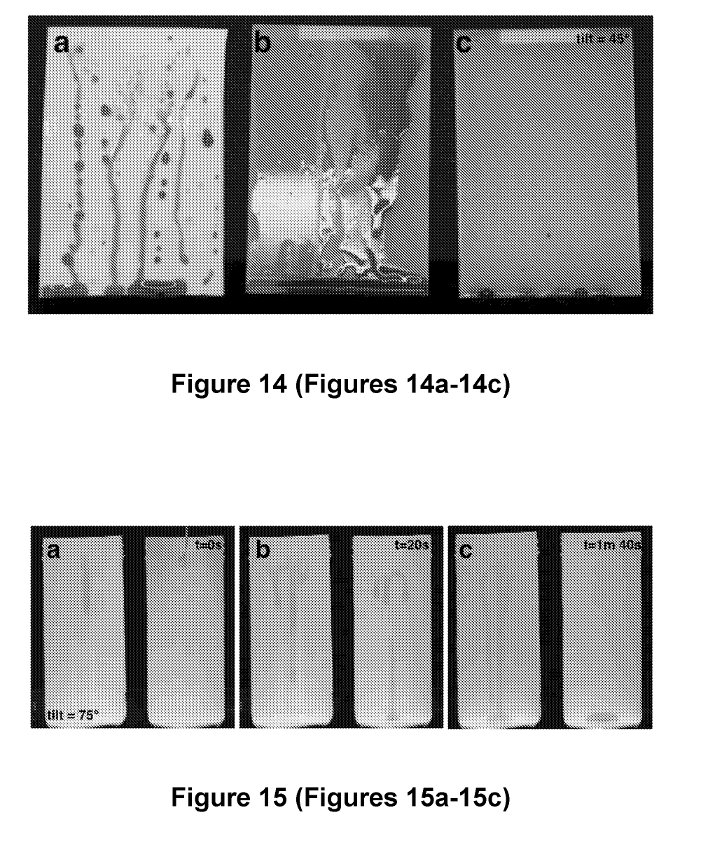

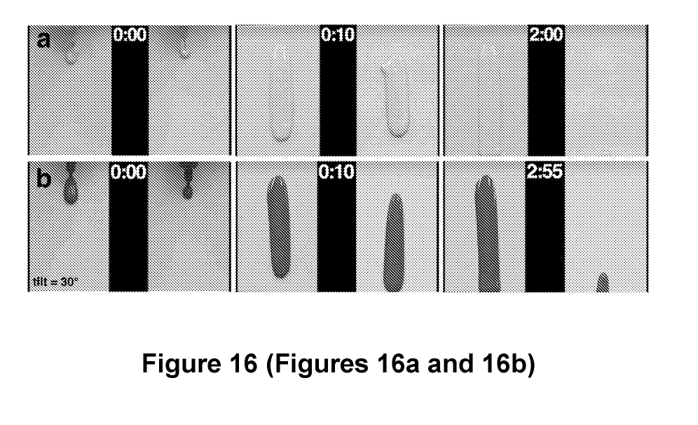

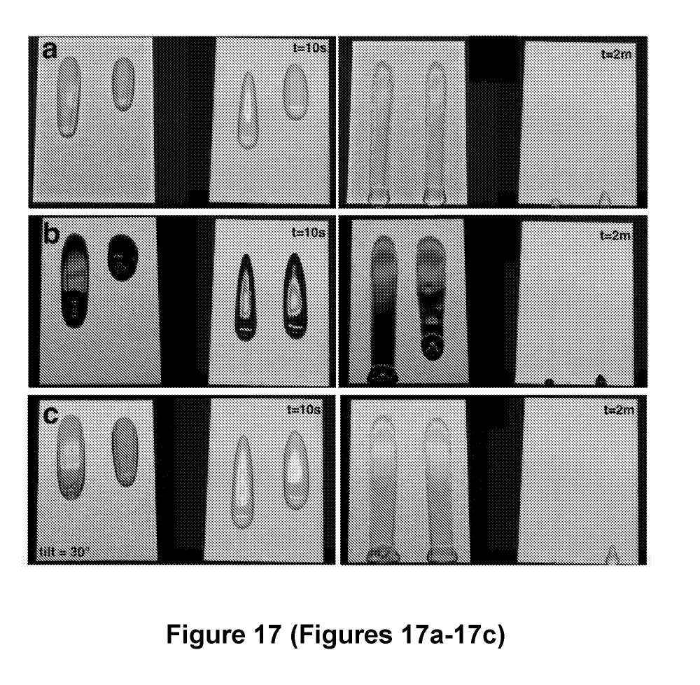

FIGS. 11-17, and their respective descriptions in the above description of the Drawings section, show and describe additional comparative examples.

The present teachings encompass embodiments in other specific forms without departing from the spirit or essential characteristics thereof. The foregoing embodiments are therefore to be considered in all respects illustrative rather than limiting on the present teachings described herein. Scope of the present invention is thus indicated by the appended claims rather than by the foregoing description, and all changes that come within the meaning and range of equivalency of the claims are intended to be embraced therein.

What is claimed is:

1. A composition for creating a functionalized, roughened surface in a single application, the composition comprising:
a solvent;
nanoparticles having a narrow particle size distribution, wherein the nanoparticles are dispersed in the solvent;
a binder, wherein the binder is soluble in the solvent; and
an additive less than 5 wt. % of the total solid components wherein the composition provides a uniformly-textured surface suitable for forming a smooth liquid lubricant overlayer surface.

2. The composition of claim 1, wherein the nanoparticles comprise a polymer.

3. The composition of claim 1, wherein the nanoparticles comprise a fluoropolymer.

4. The composition of claim 1, wherein the nanoparticles comprise an inorganic particle.

5. The composition of claim 1, wherein the nanoparticles comprise a surface modified inorganic particle.

6. The composition of claim 1, wherein the nanoparticles are monodisperse.

7. The composition of claim 6, wherein the narrow primary particle size distribution has standard deviation of about 90% from an average particle size.

8. The composition of claim 1, wherein the narrow primary particle size distribution has standard deviation of about 90% from an average particle size.

9. The composition of claim 1, wherein the median particle size of the nanoparticles is between about 20 nm to about 750 nm.

10. The composition of claim 6, wherein the median particle size of the nanoparticles is between about 20 nm to about 750 nm and wherein the size distribution of primary particle size has a standard deviation of almost 90%, from the average particle.

11. The composition of claim 1, wherein the binder comprises a fluorinated compound.

12. The composition of claim 1, wherein the solids of the composition comprise between about 10 volume % to about 75 volume % nanoparticles.

13. The composition of claim 1, further comprising one or more of an additive comprising a surfactant, a film-forming agent, a pH adjustor, a colorant, a pigment, a suspending agent, a dispersant, a wetting agent, a defoaming agent, an anti-oxidant, a UV-absorber or UV-stabilizer, a leveling agent, a stabilizing agent, a chemical modifier, and a catalyst.

14. The composition of claim 1, wherein the composition is volatile organic compound (VOC) exempt or a low VOC composition.

15. A method of forming a functionalized, roughened surface on a substrate surface, the method comprising:
dispersing nanoparticles having a narrow particle size distribution in a solvent comprising a binder to form a roughening composition;
applying the roughening composition to a substrate surface; and
removing the solvent from the roughening composition on the surface to form a coating comprising a non-hierarchical functionalized, roughened surface.

16. The method of claim 15, wherein dispersing nanoparticles comprises incorporating nanoparticles homogeneously in the solvent through a process selected from the group consisting of milling, rotor-stator usage, sonication, and combinations thereof.

17. The method of claim 15, wherein applying the roughening composition comprises one or more of spraying, brush painting, roller painting, dip coating, and spin coating the roughening composition.

18. The method of claim 15, wherein removing the solvent from the roughening composition on the surface comprises evaporating the solvent.

19. The method of claim 15, wherein removing the solvent from the roughening composition on the surface comprises controlling the rate of removal of the solvent to provide a crack-free functionalized, roughened surface.

20. The method of claim 19, wherein controlling the rate of removal of the solvent comprises at least one of altering the solvent blend, the evaporation temperature, and the evaporation humidity.

21. A method of creating a repellant surface, the method comprising:
forming a functionalized, roughened surface according to claim 15; and
applying a lubricating liquid to the functionalized, roughened surface, wherein the lubricating liquid has a chemical affinity for the functionalized, roughened surface such that, at atmospheric pressure, the lubricating liquid is substantially immobilized in, on and over the functionalized, roughened surface, without dewetting from the substrate, to form a repellant surface.

22. The method of claim 21, wherein applying a lubricating liquid comprises applying the lubricating liquid in a solvent.

23. The method of claim 21, wherein the repellant surface is a smooth liquid surface of the lubricating liquid over and above the functionalized, roughened surface.

24. The method of claim 21, wherein the lubricating liquid has a chemical affinity for the nanoparticles and/or binder.

25. The method of claim 21, wherein the chemical affinity of the functionalized, roughened surface for the lubricating liquid is greater than the chemical affinity of the functionalized, roughened surface for a foreign material to be repelled by the repellant surface.

26. An article of manufacture comprising a roughed surface made by the method of claim 21.

27. An article of manufacture with nanoscale surface texture, comprising a substrate surface of nanoparticles in a 1-2 order of magnitude size range monodispersed in one or more layers, in a binder matrix with particles projecting therefrom.

28. The article of claim 27 in combination with a lubricant adhered to the surface texture and including an overlayer stably maintained, the binder and nanoparticles having a higher affinity with the lubricant than with foreign material to be repelled by the lubricant.
